(19) United States
(12) Patent Application Publication
(10) Pub. No.: US 2021/0322919 A1
(43) Pub. Date: Oct. 21, 2021

(54) TREATMENT VESSEL, CARTRIDGE AND APPARATUS FOR TREATING A FLUID HAVING TWO TREATMENT VESSELS

(71) Applicant: Donaldson Filtration Deutschland GmbH, Haan (DE)

(72) Inventors: Abdelkhalic RBAYTI, Düsseldorf (DE); Jens SCHÄFER, Korschenbroich (DE)

(21) Appl. No.: 16/479,792

(22) PCT Filed: Jan. 22, 2018
(86) PCT No.: PCT/EP2018/051415

§ 371 Date: Jul. 22, 2019

(30) Foreign Application Priority Data
Jan. 23, 2017 (DE) 10 2017 000 518.4

(51) Int. Cl. B01D 53/04; B01D 53/26

(52) U.S. Cl. CPC B01D 53/0438; B01D 53/261; B01D 2259/4009; B01D 2257/80; B01D 2259/40096; B01D 53/0415

(57) ABSTRACT

The invention relates to a treatment vessel for an apparatus for treating a fluid, comprising a treatment material arranged in the treatment vessel and a first heater by means of which a first part of the treatment material present in a first region of the treatment vessel can be heated and a second heater by means of which a second part of the treatment material present in a second region of the treatment vessel can be heated.

The invention relates to a treatment vessel for an apparatus for treating a fluid and also to a cartridge and an apparatus for treating a fluid having two treatment vessels, and also to a process for treating a fluid.

Apparatuses for drying and filtering a fluid are known in various construction types. In a preferred embodiment, such apparatuses are configured as sorption dryers.

Sorption dryers generally serve to remove moisture from a fluid and in particular a compressed fluid, e.g. compressed air. In the production of compressed air, a compressor draws in ambient air and compresses this. The compression of the drawn-in ambient air leads to supersaturation of the compressed air with moisture. Part of this moisture condenses in an after-cooler of the compressor and is discharged from the compressed air system via separation systems. The cooling of the compressed air in the piping system between the compressor and the consumer results in further formation of condensate. This can lead to adverse accompanying phenomena which can lead to a high maintenance requirement or decreases in quality, in subsequent use of the compressed air. Applications which make high demands on the purity of the compressed air, for example applications in the food industry, the pharmaceuticals industry or in semiconductor technology, therefore frequently require additional plants for drying the compressed air and these are generally integrated into the compressed air system between the after-cooler of the compressor and the user network. These drying plants serve to feed the compressed air in virtually moisture-free form into the compressed air system.

Known sorption dryers generally have at least two vessels in which desiccate (sorbent), frequently in the form of a bed of the granular desiccant, is arranged. Adsorptive desiccants are frequently employed, with absorptive desiccants also being able to be used. The two containers are connected to one another in parallel by means of conduits and are each connected to the inlet for the fluid to be dried and the outlet for the dried fluid. The flow path of the fluid is controlled by means of valves. The control of the valves is performed by a control unit. The control of the valves is designed in such a way that the fluid to be dried always flows through one vessel. In this, the fluid is dried by the moisture present therein being bound by the desiccant present in the vessel. In this phase, this vessel is thus in a sorption or dry phase. During the sorption phase of the one vessel, part of the dried fluid (generally) flows in the opposite direction through the other vessel in order to dry, i.e. to regenerate, the sorbent which has been saturated during a preceding sorption phase. This vessel is accordingly in the regeneration phase. When the sorbent is dried without external introduction of heat energy, i.e. merely by means of a substream of the previously dried fluid, the regeneration is referred to as a cold regeneration. After a prescribed period of time which depends on the throughput through the sorption dryer, it is necessary to switch over the valves in the feed conduits and discharge conduits so that the vessel which was hitherto in the sorption phase is regenerated and the vessel which was previously regenerated is now used for drying the fluid.

In addition, hot regeneration of a sorption dryer is known from the prior art. Here, the sorption vessel which is in the regeneration phase is regenerated by means of air which has been heated by introduction of external energy. The air can either be a substream of the dried compressed air or it is also possible to use, for example, ambient air. Electric heating devices are generally used for heating the regeneration air in connection with hot regeneration.

Furthermore, installing further purified stages filled with various adsorbents or catalysts, e.g. activated carbon, which filter out further undesirable constituents of the dried fluid, for example oil vapour, downstream of such sorption dryers or other drying plants is known. Here, adsorbents which are not desiccants, i.e. do not take up any moisture, in particular no water or water vapour, and catalysts are considered to be means for purifying because they can remove further undesirable constituents of the dried fluid, in particular liquid, vapour-like or fluid-like materials, from the fluid. The means of filtering the fluid, which means are also used in the prior art in such apparatuses and whose task is to remove solids, in particular particles, from the fluid, are different therefrom.

In view of this background, it was an object of the invention to provide a treatment vessel which can be regenerated better. In particular, better treatment of a fluid or more versatile treatment of the fluid should be made possible.

This object is achieved by the treatment vessel according to claim 1 or 2, the cartridge according to claim 8 and the apparatus for treating a fluid according to claim 9 and also the process according to claim 10. Advantageous embodiments are set forth in the dependent claims and the following description.

The invention starts out from the basic idea of providing two heaters by means of which different parts of the treatment material can be heated and/or by means of which the fluid can be heated in different regions of the treatment vessel and/or by means of which different temperatures can be set in different regions.

In the hot regeneration known from the prior art, the regeneration air which has been heated by introduction of external energy before it enters the desiccant vessel flows into the desiccant vessel. The air which flows into the desiccant vessel and has been heated outside the desiccant vessel heats the parts of the desiccant which are present in the region of the fluid inlet of the desiccant vessel more strongly than the parts of the desiccant which are arranged in a region of the desiccant vessel located a distance from the fluid inlet because the fluid which has been heated outside the desiccant vessel is cooled by the heating of the part of the desiccant closer to the fluid inlet.

As a result of the invention now providing heaters which can directly heat the treatment material in the treatment vessel, it is possible to regenerate the treatment material more efficiently. Furthermore, there is the possibility of introducing heat into the treatment material without having to set a large temperature gradient over the fluid flowing through the treatment vessel. Finally, there is the possibility of heating the fluid once more in a region within the treatment vessel at a distance from the fluid inlet.

A heater by means of which part of the treatment material can be heated is, in a first embodiment, understood to mean a heater which can directly heat the treatment material, for example when surface sections of the heater are in direct contact with surface sections of the treatment material or when the heater is a radiation source and the treatment material is heated by the radiation radiated by the heater exciting elements of the treatment material. If an electric resistance wire is employed as heater and it is provided that the resistance wires glows during operation, a sheathing of the resistance wire which prevents direct contact of the treatment material with the glowing resistance wire can also be provided as part of the heater. The heater can also heat the fluid within the treatment vessel so that the treatment material is heated and/or dried directly by the fluid heated by the heater in the treatment vessel.

Treatment of a fluid is understood to mean the removal of a component of the fluid. The treatment can be a filtration in which the materials which have a different state of matter than the other materials of the fluid are removed from the fluid, i.e. in the case of an essentially gaseous fluid, solid particles or liquid particles are removed from the essentially gaseous fluid or, in the case of an essentially liquid fluid, solid particles are removed from the essentially liquid fluid. Filtration can, in particular, be effected by coalescence filtration, particle filtration or process filtration. The treatment can be a purification in which removal of gaseous constituents or constituents in the form of vapour from gases occurs. A purification can particularly preferably be effected by absorption, adsorption, catalysis or condensation. The treatment can be a separation in which removal of liquid constituents from liquids occurs. A separation can particularly preferably be a membrane separation, an adsorption, a sedimentation or a flocculation.

The treatment material can, for example, be a bed and will have fluid in the interstices between the particles of the bed. This fluid can be heated by the heater when it is present in the treatment vessel. In addition, it is possible to conceive of embodiments in which the heater heats part of the particles of a treatment material by direct contact and heats another part of the particles of the treatment material indirectly by heating of the fluid present between the particles.

In a preferred embodiment, the treatment material is a bed, in particular a bed of granular desiccant. The treatment material can be an adsorptive treatment material, in particular an adsorptive desiccant, or else an absorptive treatment material, in particular an absorptive desiccant, or else a mixture of adsorptive and absorptive treatment material. Furthermore, the bed can, in addition or as an alternative, comprise other elements such as catalysts, for example activated carbon. The treatment material can be a coalescence medium. In a preferred embodiment of a treatment material in the form of a coalescence medium, a drainage layer is additionally provided. The treatment material can be suitable for hot drying. The treatment material can also be suitable for cold drying. The treatment material can be a membrane, for example for membrane drying.

In a preferred embodiment, the first part of the treatment material is arranged in a first cartridge and the second part of the treatment material is arranged in a second cartridge, with the first cartridge and the second cartridge being arranged in the treatment vessel. It is also possible to conceive of embodiments in which more than two, particularly preferably more than three, more than four or more than five, cartridges are arranged in the treatment vessel. Desiccant vessels in which the desiccant is arranged in a plurality of cartridges in order to simplify replacement of the desiccant are known. This can also be realized in the case of the treatment vessel of the invention. The cartridges are preferably stacked on top of one another in the treatment vessel. In a preferred embodiment, at least one of the two cartridges has an inlet opening through which fluid within the treatment vessel can flow into the cartridge and come into contact with the treatment material, in particular the desiccant, arranged in the cartridge. The at least one of the two cartridges can additionally have a fluid exit opening through which fluid can exit from the cartridge. In this embodiment, a first heater can be provided in the region of the inlet opening of the cartridge and there heat the fluid flowing into the cartridge, as a result of which the part of the treatment material which is present in the first cartridge is also heated, namely by contact with the fluid which has been heated at the inlet opening of the cartridge. In addition and as an alternative, a heater by means of which fluid flowing out from the cartridge can be heated can be provided at the outlet opening of the cartridge. In this way, the part of the treatment material which is arranged in the next, downstream cartridge is heated, namely by contact with the fluid which has been heated while flowing out from the first cartridge by means of the heater provided there and then flows through an entry opening of the second cartridge into the second cartridge.

This makes various embodiments of the invention possible. For example, it is possible, in a first embodiment, to use a first cartridge and a second cartridge which each have an inlet opening through which fluid can flow into the respective cartridge and in which a heater which can heat the fluid passing through the inlet opening or which has passed through the inlet opening and can thus heat the part of the treatment material present in the cartridge can be provided in the region of the respective inlet opening. The fluid which flows in succession through the cartridges in a preferred embodiment is thus heated in the region of the inlet opening of the respective cartridge and, during further passage through the cartridge, then heats the respective part of the treatment material present in the cartridge. This embodiment offers, in particular, the advantage that all cartridges can be made with the same configuration, which allows mass production of the cartridges and also simplifies servicing work, since it is no longer necessary to pay attention to a particular order of the cartridges.

As an alternative, it is possible to conceive an embodiment in which the first cartridge has an inlet opening through which fluid can flow into the cartridge and has a heater in the region of the inlet opening by means of which the part of the treatment material present in the first cartridge can be heated by the fluid which has been heated in the region of the inlet opening coming into contact with the part of the treatment material present in the cartridge. In this embodiment, the first cartridge additionally has an outlet opening and in the region of the outlet opening has a heater which heats the fluid flowing out from the first cartridge. The second cartridge is configured without a dedicated heater. The heater present in the region of the outlet opening of the first cartridge heats the fluid on exit from the first cartridge. The fluid which has been heated in this way goes through the inlet opening of the second cartridge into the cartridge and there heats the part of the treatment material present there. This embodiment offers the advantage that only a part of the cartridges has to be configured with the additional elements for the heater, in particular have power connections which may have to be provided, while the second part of the cartridges can have a simple configuration and, for example, does not have to have any particular feed conduits.

In an alternative embodiment, it is possible to provide a flow region within the treatment vessel between the first cartridge and the second cartridge through which the fluid exiting from the first cartridge flows before it enters the second cartridge. In this embodiment, it is possible to provide a heater which heats the fluid flowing through this flow region and thus indirectly heats the part of the treatment material which is arranged in the cartridge which is arranged downstream of this flow region and into which the heated fluid flows and there heats this part of the treatment material.

In a preferred embodiment, the heater has an element which is arranged within the cartridge, particularly preferably an element which is in contact with the treatment material in the cartridge, for example a heating wire which is passed through parts of the treatment material present in the cartridge. When cartridges are used, embodiments in which the heating wire is provided in the region of an inlet opening and/or an outlet opening of the cartridge are conceivable. The inlet opening will be delimited by margins which in the flow direction of the fluid will have a particular thickness which usually depends on the wall thickness of the cartridge, even though it is conceivable to provide a thickening which surrounds the respective opening and is thicker than the remaining wall thickness of the cartridge in order to reinforce the inlet opening or outlet opening. The heating wire can be arranged in a region which is surrounded by the margin, i.e. essentially directly in the opening. It is likewise conceivable for the heating wire to be transposed a little toward the inside in the cartridge so that it heats fluid which has just passed through the opening. It is likewise conceivable for the wire to be transposed a little to the outside, so that it heats fluid directly before it goes in through the opening. The same applies to the outlet opening with a converse flow direction. To protect the heating wire, preference is given to embodiments in which the heating wire is located directly in the opening or is transposed a little into the interior of the cartridge. However, it is also possible to conceive of circumstances, for example particular treatment materials which should not come into direct contact with the heating wire, in which the heating wire is preferably arranged directly in the inlet opening or transposed a little towards the outside. It is likewise possible to conceive of constructions in which a heater directly heats the treatment material in the cartridge, for example by infrared radiation or by microwave radiation.

In a preferred embodiment, the first heater and/or the second heater is a heating wire, an infrared radiator or a microwave transmitter. In a preferred embodiment, all heaters of the treatment vessel according to the invention have the same configuration. This simplifies the construction of the treatment vessel according to the invention.

The use of a heating wire as heater according to the invention offers the advantage that such a heating wire can, in a preferred embodiment, also be used as flow metre. If the heating wire is arranged in such a way that the fluid flows over it, the heating wire is cooled as a function of the volume flow of the fluid. This alters the resistance of the heating wire. This change in the resistance of the heating wire can be used for drawing conclusions as to the volume flow passed over the heating wire.

The heating wire can also be used to determine the hours of operation of a treatment vessel in which the heating wire is arranged, or the hours of operation of a cartridge at or in which the heating wire is arranged.

In embodiments where the heater is used as flow metre or as means to determine the hours of operation of a treatment vessel, the treatment vessel preferably is provided with a control unit. This control unit can be a control unit that is used to control the working of the treatment vessel, for example that is used to control the switching of the flow of fluid through a first vessel and a second vessel. The control unit can, however, also be a control unit purposefully provided for the evaluation of signals or readings obtained from the heater. Such a control unit can, for example, be provided on a cartridge.

In a preferred embodiment to determine the temperature or the hours of operation of a treatment vessel, the fluid is made to flow over heating wires that function as heaters. The electronics of the control unit drive the heating wires by a PDM signal (pulse duration modulation). The temperature can, for example, be determined after every PDM signal. The flow of fluid will cool down the heating wires. By knowing the temperature which the wires should have after a PDM signal, which can be easily obtained by simple tests, and by looking at the temperature the wires effectively have, the controller could calculate how high the current flow is.

If a control unit is provided on the cartridge, the control unit can send the information via a wire or wireless to a controller.

The electronic communicate can take place via a secure communication protocol.

The use of a heating wire can also be employed for identifying the treatment vessel in which it is installed or the cartridge at or in which the heating wire is installed. For example, instead of identification of the respective cartridge by means of an RFID chip, identification of the respective cartridge can be made possible by the heating wire being given a property which is different from other heating wires. The individualization of the individual cartridges by means of the heating wire offers the advantage that it is possible to display error signals if incorrect cartridges are installed in a treatment vessel. The working performance of the cartridges installed in a treatment vessel frequently depends on the correct order of the cartridges which may contain different types of a treatment material. If the cartridges are identifiable via the particular configuration and identifiable configuration of their respective heating wire, it is possible to query, by means of a control unit, whether the correct cartridges and in particular the correct order of cartridges has been installed in the treatment vessel.

In a preferred embodiment, the treatment vessel is configured essentially as a cylinder which at one end has a fluid inlet through which fluid flows into the treatment vessel and at the opposite end has a fluid outlet through which fluid flows out from the treatment vessel.

In a preferred embodiment of a treatment vessel configured as a cylinder, the second region is behind the first region in the longitudinal direction of the cylinder and/or the second region is further away from the central axis of the cylinder in a radial direction of the cylinder than the first region. Applications in which parts of the treatment material arranged one behind the other are to be heated by means of separate heaters are conceivable. In addition or as an alternative, it can be advantageous to ensure that parts of the treatment material which are at a distance from one another in the radial direction are heated by means of separate heaters. This offers advantages particularly when the fluid flowing through the treatment vessel does not flow sufficiently uniformly over the flow cross section of the treatment material and for this reason only the parts of the treatment material located in a core flow region are heated, while regions of the treatment material located outside this core flow are heated only slightly or not at all.

The apparatus of the invention for treating a fluid has two treatment vessels of which at least one treatment vessel, particularly preferably both treatment vessels, is/are a treatment vessel according to the invention. In a preferred embodiment, the apparatus is a sorption dryer. The apparatus particularly preferably has a bed, particularly preferably of granular treatment material, in particular desiccant, as treatment material. The treatment material is particularly preferably at least partly arranged in an exchangeable cartridge. In a preferred embodiment, the treatment material is adsorptive, absorptive or consists of a mixture of adsorptive and absorptive treatment materials.

The cartridge according to the invention for use in an apparatus for treating a fluid has a treatment material arranged in the cartridge and also a heater by means of which the treatment material present in the cartridge can be heated.

In a preferred embodiment, the cartridge is used in a treatment vessel according to the invention.

The process of the invention for treating a fluid using an apparatus according to the invention provides for a fluid to flow through the treatment material present in a treatment vessel of the invention and, while the fluid flows through the treatment material, for the fluid to be heated by means of the first heater in a first region of the treatment vessel and/or a first part of the treatment material present in a first region of the treatment vessel to be heated by means of the first heater and/or the fluid to be heated by means of a second heater in a second region of the treatment vessel and/or a second part of the treatment material present in a second region of the treatment vessel to be heated by means of the second heater. The fluid here is particularly preferably a regeneration fluid which flows through the treatment vessel after a fluid to be treated, for example a fluid to be dried, has previously flowed through the treatment vessel and has thus loaded the treatment material.

However, it has been recognized according to the invention that heating of the treatment material can offer advantages not only in the regeneration of the treatment material. In addition, the energy introduced for heating the treatment material can also be used to activate further elements provided in the treatment vessel and increase their effectiveness. Thus, it is conceivable, for example, to keep the treatment material as a bed and also provide catalysts whose effectiveness can be increased by introduction of heat as part of the bed. In addition or as an alternative, it is possible in the apparatus of the invention for a different fluid then to be passed through the treatment material and, while the other fluid flows through the treatment material, for a first part of the treatment material present in a first region of the treatment vessel to be heated by means of the first heater and/or a second part of the treatment material present in a second region of the treatment vessel to be heated by means of a second heater. In this embodiment of the process of the invention, the heat introduced by the heaters is, in particular, used to improve the regeneration of the treatment material. The other fluid which is passed through the treatment material can be a substream of a fluid which has been dried in another treatment vessel of the apparatus. In addition or as an alternative, the other fluid can, for example, be a fluid which has been taken from the surroundings of the apparatus or has been taken from a fluid stock.

In the process of the invention, operating situations in which only one of the two heaters provided is active are conceivable. For example, it is conceivable for the regeneration of the treatment material in the treatment vessel to occur in different stages and, for example, both heaters to be activated in a first regeneration phase in which the treatment material is still highly loaded with moisture, while only one of the heaters is activated in a final phase of the regeneration.

The invention is explained in more detail below with the aid of a drawing showing a merely illustrative example of the invention. The drawing shows:

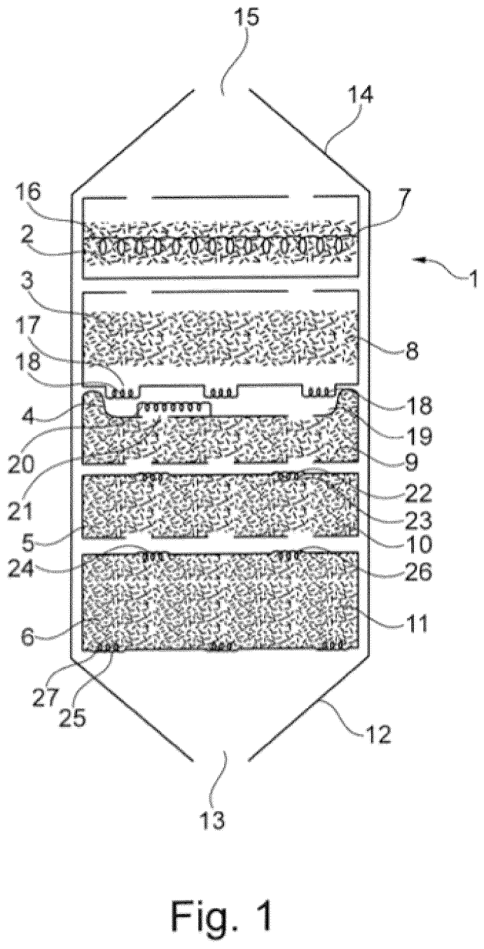

FIG. 1 a schematic sectional view of a desiccant vessel according to a first embodiment of the invention and

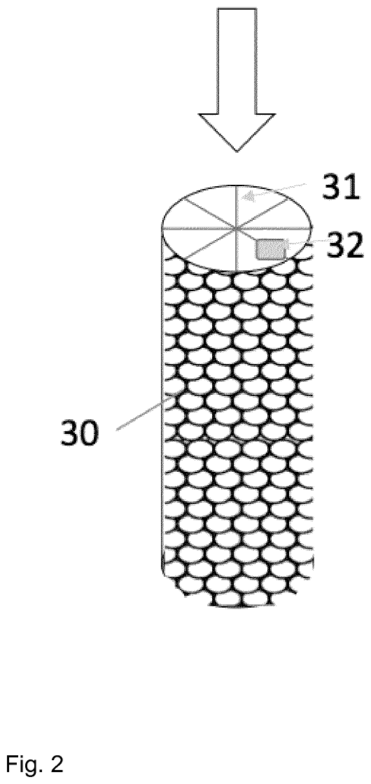

FIG. 2 a schematic drawing of a cartridge with a heater used as a temperature sensor or a flow meter.

FIG. 1 shows a treatment vessel according to the invention in the form of a desiccant vessel 1 for an apparatus for drying a fluid. Five cartridges 2, 3, 4, 5, 6 are arranged in the desiccant vessel. A first part 7 of the desiccant is arranged in the first cartridge 2. A second part 8 of the desiccant is arranged in the second cartridge 3. A third part 9 of the desiccant is arranged in the cartridge 4. A fourth part 10 of the desiccant is arranged in the cartridge 5 and a fifth part 11 of the desiccant is arranged in the cartridge 6.

The desiccant vessel 1 has an essentially cylindrical configuration and has a top part 12 with a fluid inlet 13 and an end part 14 with a fluid outlet 15. To carry out drying, the fluid to be dried flows through the desiccant vessel 1 from the fluid inlet 13 to the fluid outlet 15. To carry out regeneration of the desiccant present in the desiccant vessel 1, the fluid used for regeneration can flow through the desiccant vessel in counter current, i.e. enter at the fluid outlet 15 and exit from the fluid inlet 13.

The cartridge 2 has a first heater in the form of a heating wire 16 which runs right across the cartridge 2 and is in contact with particles of the first part 7 of the desiccant present in the cartridge 2. The heating wire 16 can heat the first part 7 of the desiccant present in the cartridge 2 by direct areal contact with the particles in contact with it, also by heat radiation and additionally by heating of the fluid stream flowing through the cartridge 2 which then in turn heats the particles around which it flows.

The cartridge 3 has three inlet openings 17 through which fluid can flow into the cartridge 3. Heating wires 18 are provided as second heater for the desiccant vessel according to the invention in the region of the inlet openings 17. The heating wires 18 can heat the fluid flowing through the inlet openings 17 and thereby the second part 8 of the desiccant which is present in the cartridge 3, namely by the fluid which has been heated by the heating wires 18 flowing over the particles of the desiccant in the cartridge 3.

In addition and as an alternative to the heating wires 18, a heating wire 20 can be provided as further heater in a flow region 19 formed between the cartridge 3 and the cartridge 4. This heating wire 20 can heat fluid exiting from the exit openings 21 of the cartridge 4 and thereby heat the second part 8 of the desiccant present in the cartridge 3, namely by the fluid which has been heated by the heating wire 20 going into the cartridge 3 and heating the desiccant present there.

The cartridge 5 has exit openings 22. Heating wires 23 which can heat the fluid flowing through the exit openings 22 are provided in the region of the exit openings 22. In this way, the heating wires 23 can heat the third part 9 of the desiccant present in the desiccant vessel by the fluid which has been heated by the heating wires 23 going into the cartridge 4 and heating the desiccant present therein. In the cartridge 6, heating wires 25 and 26 are provided both in the inlet openings 27 and also in the exit openings 24. The fifth part 11 of the desiccant present in the desiccant vessel 1 can be heated by means of the heating wires 25, namely by the fluid flowing through the inlet openings 27 being heated by the heating wires 25 and heating the desiccant present in the cartridge 6 by flowing over this desiccant. The fourth part 10 of the desiccant present in the desiccant vessel 1 can be heated by means of the heating wires 26, namely by the fluid exiting from the exit openings 24 being heated by the heating wires 26 and entering the cartridge 5 and heating the desiccant present therein.

The cartridges 2, 3, 4, 5, 6 depicted in FIG. 1 show possible embodiments of the cartridges according to the invention. They are shown together in FIG. 1 purely for illustrative purposes. A desiccant vessel according to the invention will, in a preferred embodiment, have only cartridges of the same type, i.e., for example, only cartridges of the type illustrated by the cartridge 2 or only cartridges of the type illustrated by the cartridge 3 or only cartridges having a heater arranged in a flow region between two cartridges (cf. cartridges 3 and 4) or only cartridges of the type described with the aid of the cartridge 5 or only cartridges of the type described with the aid of the cartridge 6. It is likewise conceivable for a desiccant vessel according to the invention to have cartridges of the type illustrated by the cartridge 6 alternating with cartridges which have no heating element.

FIG. 2 shows a cartridge 30 with heating wires 31 arranged in a star shaped arrangement at the inlet opening of the cartridge 30. Also arranged on the inlet side of the cartridge is a control unit 32. If fluid is made to flow over heating wires 31 that function as heaters and the electronics of the control unit 32 drive the heating wires by a PDM signal (pulse duration modulation), the temperature can, for example, be determined after every PDM signal. The flow of fluid will cool down the heating wires. By knowing the temperature, which the wires should have after a PDM signal, which can be easily obtained by simple tests, and by looking at the temperature the wires effectively have, the controller could calculate how high the current flow is.

1. Treatment vessel, in particular treatment vessel (1) for an apparatus for treating a fluid, comprising
a treatment material arranged in the treatment vessel (1) and
a first heater by means of which the fluid can be heated in a first region of the treatment vessel (1) and/or by means of which a first part (7) of the treatment material present in a first region of the treatment vessel (1) can be heated and
a second heater by means of which the fluid can be heated in a second region of the treatment vessel (1) and/or by means of which a second part (8) of the treatment material present in a second region of the treatment vessel (1) can be heated.

2. Treatment vessel, in particular treatment vessel (1) for an apparatus for treating a fluid, comprising
a treatment material arranged in a cartridge (30) arranged in the treatment vessel (1) and
a first heater which is provided on the cartridge and by means of which the fluid can be heated in a first region of the treatment vessel (1) and/or by means of which a first part (7) of the treatment material present in a first region of the treatment vessel (1) can be heated.

3. Treatment vessel according to claim 2, characterized by a second cartridge which is arranged in the treatment vessel (1) and contains a treatment material arranged in the cartridge and a second heater which is provided on the second cartridge and by means of which the fluid can be heated in a second region of the treatment vessel (1) and/or by means of which a second part (8) of the treatment material present in a second region of the treatment vessel (1) can be heated.

4. Treatment vessel according to any of claims 1 to 3, characterized in that the treatment material is a bed.

5. Treatment vessel according to any of claims 1 to 4, characterized in that the first part (7) of the treatment material is arranged in a first cartridge (2) and the second part (8) of the treatment material is arranged in a second cartridge (3) and the first cartridge (2) and the second cartridge (3) are arranged in the treatment vessel (1).

6. Treatment vessel according to any of claims 1 to 5, characterized in that the first heater and/or the second heater has a heating wire (16, 18, 20, 23, 25, 26, 31), an infrared radiator or a microwave transmitter.

7. Treatment vessel according to any of claims 1 to 6, characterized in that the treatment vessel (1) is essentially a cylinder, with the second region being located after the first region in the longitudinal direction of the cylinder and/or the second region being located further away from the central axis of the cylinder in the radial direction of the cylinder than the first region.

8. Cartridge (2, 3, 5, 6) for use in an apparatus for treating a fluid, characterized in that a treatment material is arranged in the cartridge (2, 3, 5, 6) and in that a heater is provided by means of which a fluid present in the cartridge (2, 3, 5, 6) or flowing through the cartridge can be heated and/or the treatment material present in the cartridge (2, 3, 5, 6) can be heated.

9. Apparatus for treating a fluid having two treatment vessels (1) through which the fluid can flow for treatment, characterized in that at least one of the treatment vessels (1) is a treatment vessel (1) according to any of claims 1 to 7.

10. Process for treating a fluid using an apparatus according to claim 9, characterized in that a fluid flows through the treatment material present in a treatment vessel (1) according to any of claims 1 to 7 and the fluid is heated by means of the first heater in a first region of the treatment vessel (1) and/or a first part (7) of the treatment material present in a first region of the treatment vessel is heated by means of the first heater and/or the fluid is heated by means of a second heater in a second region of the treatment vessel (1) and/or a second part (8) of the treatment material present in a second region of the treatment vessel (1) is heated by means of the second heater.

11. Process for treating a fluid according to claim 10, characterized in that another fluid then flows through the treatment material and the other fluid is heated in a first region of the treatment vessel (1) by means of the first heater and/or a first part (7) of the treatment material present in a first region of the treatment vessel is heated by means of the first heater and/or is heated in a second region of the treatment vessel (1) by means of a second heater and/or a second part (8) of the treatment material present in a second region of the treatment vessel is heated by means of the second heater.
